(19) United States
(12) Patent Application Publication
(10) Pub. No.: US 2005/0060156 A1
(43) Pub. Date: Mar. 17, 2005

(54) Speech synthesis

(76) Inventors: Gerald E. Corrigan, Chicago, IL (US); Steven W. Albrecht, Glenview, IL (US)

Correspondence Address: MOTOROLA, INC., 1303 EAST ALGONQUIN ROAD, IL01/3RD, SCHAUMBURG, IL, 60196, US

(21) Appl. No.: 10/914,583

(22) Filed: Aug. 9, 2004

Related U.S. Application Data
(60) Provisional application No. 60/503,685, filed on Sep. 17, 2003.

(51) Int. Cl. G10L 21/00; G10L 13/00

(52) U.S. Cl. 704/270.1; 704/258

(57) ABSTRACT

In a speech synthesis technique used in a network (110, 115), a set of text words is accepted by a speech engine software function (210) in a client device (105). From the set of text words, an invalid subset of text words is determined for which the text words are not in a word synthesis dictionary of the client device. The invalid subset of text words is transmitted over the network to a server device (120), which generates a set of word pronunciations including at least a portion of the text words of the invalid subset of text words and pronunciations associated with each of the text words. The client device uses the pronunciations for speech synthesis and may store them in a local word synthesis dictionary (220) stored in a memory (150) of the client device.

### BACKGROUND

Speech synthesis, or text-to-speech (TTS) conversion, requires that pronunciations be determined for each word in the text. The process controlling the conversion, known as a speech engine, typically has access to one or more pronunciation dictionaries, or lexical files, that store pronunciations of text words that are expected to be processed by the speech engine. For example, one pronunciation dictionary may be a dictionary of common words and another pronunciation dictionary may be provided to the search engine by a particular software application for words that are unique to the application, while the application is running. However, it can be expected that some words are not in a given set of pronunciation dictionaries, so methods are also included in the speech engine for generating pronunciations for unknown words without using a pronunciation dictionary. These methods are error-prone.

TTS is a highly desirable feature in many situations, of which two examples are when a cellular telephone is being used by a driver, and when a cellular phone is used by a sight impaired person. Thus, TTS is valuable in electronic devices having limited resources, so there is a challenge to minimize the size of pronunciation dictionaries used in such resource limited devices, while at the same time minimizing pronunciation errors for unknown words.

The two examples described above are situations of a client device (a cellular telephone) that are typically operated in a radio communication system, by which the client devices can be connected to the world-wide-web. The world-wide-web consortium (W3C) is developing a standard for pronunciation dictionaries for speech applications written using such tools as VoiceXML (located at URL www.w3.org/TR/lexicon-reqs).

### BRIEF DESCRIPTION OF THE DRAWINGS

The present invention is illustrated by way of example and not limitation in the accompanying figures, in which like references indicate similar elements, and in which:

FIG. 1 is an electrical block diagram that shows a communication system that includes a client device in accordance with an embodiment of the present invention.

FIG. 2 is a software block diagram that shows a programming model of the client device of FIG. 1.

FIG. 3 is a flow chart of a method of speech synthesis method used in the communication system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the text to speech (TTS) conversion techniques in accordance with the present invention, it should be observed that the present invention resides primarily in combinations of method steps and apparatus components related to TTS conversion. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

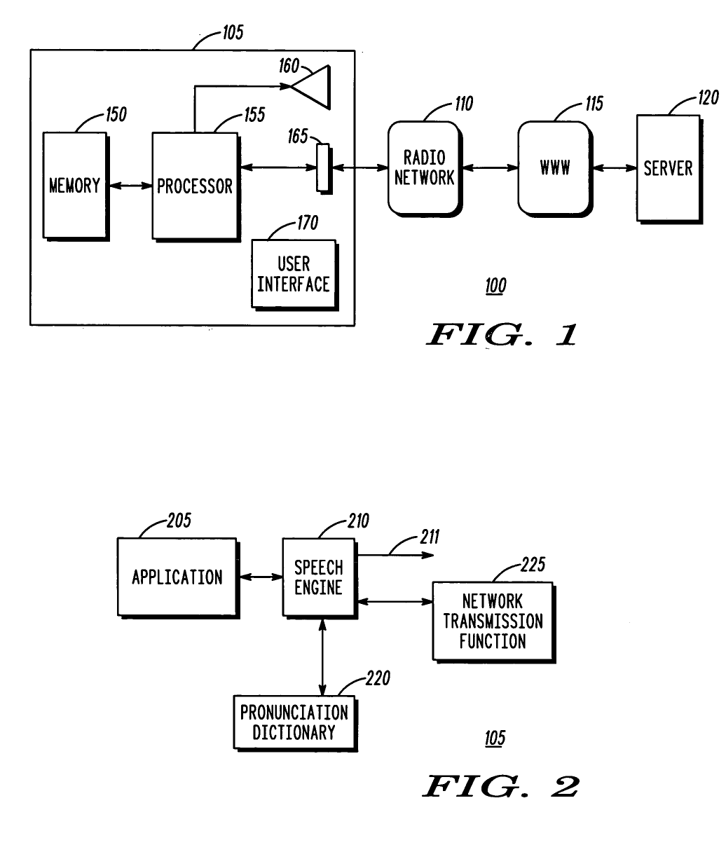

Referring to FIG. 1, an electrical block diagram of a communication system 100 is shown, in accordance with an embodiment of the present invention. The communication system 100 comprises a first device 105 that is a client device in the communication system 100, such as a personal communication device, of which one example is a cellular telephone. The client device 105 is coupled to a radio communication network 110, which in turn is coupled to the world-wide-web 115, which of course is an information network that primarily uses wired and optical connections, but may include some radio connections. A second device 120 that is a server device is also coupled to the world-wide-web 115.

The client device 105 comprises a processor 155 that is coupled to a memory 150, a speaker 160, a network interface 165, and a user interface 170. The processor 155 may be a microprocessor, a digital signal processor, or any other processor appropriate for use in the client device 105. The memory 150 stores program instructions that control the operation of the processor 155, and may use conventional instructions to do so, in a manner that provides a plurality of largely independent functions. Some of the functions are those typically classified as applications. Many of the functions may be conventional, but certain of them described herein are unique at least in some aspects. The memory 150 also stores information of temporary, short lived, and long lived duration, such as cache memory and tables. Thus memory 150 may comprise storage devices of differing hardware types, such as Random Access Memory, Programmable Read Only Memory, Flash memory, etc. The speaker 160 may be a speaker as is found in conventional client devices such as cellular telephones. The network interface 165 may be a radio transceiver as found in a cellular telephone, or when the client device is, for example, a Bluetooth connected device, the network interface would be a Bluetooth transceiver. The network interface 165 could alternatively be a wireline interface for a client device that operates via a personal area network to a client device (not shown) that is connected by a radio network 110 to the world-wide-web, or could alternatively be a wireline interface for a client device that is connected directly to the world-wide-web 115. The world-wide-web 115 could alternatively be a sizable private network, such as a corporate network supporting several thousand users in a local area. The user interface 170 may be a small or large display and a small or large keyboard. The server device 120 is preferably a device with substantial memory capacity in relationship to the client device 105. For example, the server typically will have a large hard drive or drives (for example, 20 gigabytes of storage).

Referring to FIG. 2, a programming model of the client device 105 is shown, in accordance with embodiment of the present invention described with reference to FIG. 1. An application 205 and a word synthesis dictionary 220 are coupled to a speech engine 210. A network transmission function 225 is coupled to the speech engine 210. The application 205 is one of several software applications that may be coupled to the speech engine 210, and is an application that generates a set of text words that are to be synthesized by the speech engine 210 which generates an analog signal 211 to provide an audible presentation using the speaker 160 of the client device 105. The speech engine 210 may have embedded in its programming instructions and data within the memory 150 a function for synthesizing a voice presentation of a word directly from the combination of letters of the word. As is well known, such synthesis typically sounds quite artificial and can often be wrong, causing a user to misinterpret the words. Accordingly, the word synthesis dictionary 220 is provided and may comprise a set of common words and an associated set of pronunciations for the words, which reduces the misinterpretation of the words by a user. The word synthesis dictionary 220 may in fact comprise more than one set of words merged together. For example, a default set of common words and their pronunciations that is unchanged for differing applications may be combined with a set of words and their pronunciations associated with a specific application that are merged into the dictionary when the specific application is running. This can be effective when a set of differing applications are predetermined for use with the speech engine. For example, a telephone dialer may provide different words to the speech engine 210 than would a web browser. However, this approach can cause problems in the amount of memory that must be associated with each application to store the words and their pronunciations, as well as knowledge of exactly which words are stored by default in the dictionary 220. However, the word synthesis dictionary, being located in a client device, can be fairly limited in its storage capacity (e.g., less than a megabyte).

In one embodiment of the present invention, an application may present a set of text words (without associated pronunciations) to the word synthesis dictionary 220 in the memory 150. The set of text words may be a set of text words commonly used by the application, which are expected to be used by the application within a relatively short period of time—while the application is running (for example, anywhere from a part of a minute to many minutes), or, alternatively, they may be a set of text words that comprises a speech text. A speech text in the context of this application is a set of text words that are planned for imminent sequential presentation through the speaker 160. For example, the sentence “The number entered is 847-576-9999” prepared for presentation to user in response to the user's entry of a phone number would be speech text. The digits 0, 1, 2, 3, 4, 5, 6, 7, 8, 9 are examples of text words which would more likely be the set of digits anticipated for use by an address application. By a technique described below, the pronunciations of words not in the client device's word synthesis dictionary 220 are obtained remotely. For this purpose, the speech engine 210 is coupled to the network transmission function 225 for transmitting words over the network that are not in the client device's word synthesis dictionary 220.

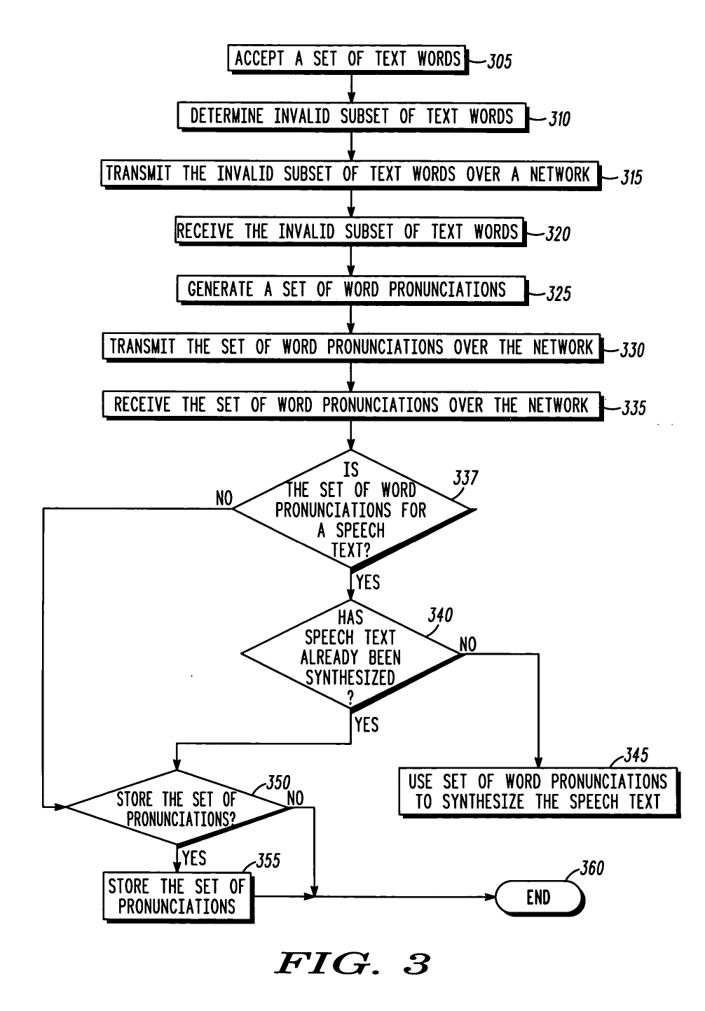

Referring to FIG. 3, a method is shown for speech synthesis, in accordance with embodiments of the present invention. The set of text words, whether speech text or otherwise, is accepted at step 305 by a function (such as the speech engine 210) associated with the word synthesis dictionary 220 that determines at step 310 whether the presently configured word synthesis dictionary 220 includes the pronunciation of the set of text words. A resulting subset of text words for which pronunciations are not found comprises a subset of invalid words (when there are one or more such words). The client device 105 then transmits the invalid subset of text words at step 315 over a network to a server device. In the example described above with reference to FIG. 1, the network comprises the radio network 110 and the world-wide-web 115, but the network may comprise a wired network without a radio network. The server device 120 receives the invalid subset of text words at step 320 and by referring to a large word synthesis dictionary within or accessible to the server device 120, generates a set of word pronunciations at step 325 for the invalid set of text words. By being located within a server or other computer that is typically a fixed network device, the word synthesis dictionary can be large enough (e.g., greater than a gigabyte) to encompass virtually all words needed by all the client devices it serves. The server device 120 preferably generates the set of word pronunciations to include all of the text words of the invalid subset of text words. The set of word pronunciations could, of course, encompass as few as none of the text words. For the set of word pronunciations generated by the server, there is a pronunciation associated with each of the text words. At step 330, the server transmits the set of word pronunciations over the network (or networks, as the case may be) to the client device 105.

When the client device 105 receives the set of word pronunciations at step 335, the client device 105 makes a determination whether the set of word pronunciations is associated with a speech text at step 337. At step 340, a determination whether the speech text has already been presented (synthesized). When the speech text has not yet been synthesized, the set of word pronunciations is used by the speech engine 210 at step 345 to provide a synthesis of the speech text, thereby reducing interpretation errors. When the speech text has already been synthesized at step 340 (as in the case in which the delay to receive the set of word pronunciations exceeds a minimum specified delay time, or the case in which a command to present the speech text is received before the set of word pronunciations is received), or when the set of word pronunciations is determined not to be for a speech text at step 337, the client device 105 at step 350 determines whether the set of pronunciations is to be stored in the memory 150 of the client device 105 as an addition to the word synthesis dictionary of the client device 105. Such storage may be for a predetermined time, e.g., while the application that requested the set of word pronunciations is active, or for example, based on limits of the memory 150, or, for example, based on a priority of the application and memory limits and/or time, etc. When the set of pronunciations is to be stored in the memory 150, they are stored at step 355. The process ends at step 360.

It will be appreciated that the present invention provides a unique technique for providing pronunciations of textwords in a client device having a restricted word synthesis dictionary capacity (e.g., less than one megabyte), thereby reducing misinterpretation errors.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used in the following claims, means a non-empty set. The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

1. A method used in a client device for speech synthesis, comprising:
accepting a set of text words;
determining an invalid subset of the set of text words, for which invalid subset the text words are not in a word synthesis dictionary of the client device; and
transmitting the invalid subset of text words over a network to a server device.

2. The method according to claim 1, wherein the set of text words comprises a speech text.

3. The method according to claim 1, wherein the set of text words comprises a set of words related to a particular application.

4. The method according to claim 1, further comprising:
receiving a set of word pronunciations over the network comprising zero or more of the text words of the invalid subset of text words, for which set of word pronunciations there is a pronunciation associated with each of text words.

5. The method according to claim 4, further comprising:
generating a synthesis of a word in the set of text words using at least one pronunciation from the set of word pronunciations.

6. The method according to claim 5, wherein generating a synthesis using at least one pronunciation is performed when the set of word pronunciations is received before a command to synthesize the set of text words is generated.

7. The method according to claim 4, further comprising:
adding at least one word pronunciation from the set of word pronunciations to the word synthesis dictionary of the client device.

8. The method according to claim 7, wherein adding at least one word pronunciation to the word synthesis dictionary is performed when the set of word pronunciations is received after a command to synthesize the set of text words is generated.

9. A method used in a network for speech synthesis,
comprising at a first device:
accepting a set of text words;
determining an invalid subset of the set of text words, for which the text words are not in a word synthesis dictionary of the first device; and
transmitting the invalid subset of text words over a network;
further comprising at a second device:
receiving the invalid subset of text words from the first device;
generating a set of word pronunciations comprising zero or more of the text words of the invalid subset of text words, for which set of word pronunciations there is a pronunciation associated with each of the text words; and
transmitting the set of word pronunciations to the first device over the network; and
further comprising at the first device:
receiving the set of word pronunciations.

10. A device for speech synthesis, comprising:
a processor;
a memory that stores program instructions that control the processor to perform
an application function that generates a set of text words,
a local word synthesis dictionary function that stores text words and pronunciations therefore, and
a speech engine that accepts the set of text words and determines an invalid subset of the set of text words, for which invalid subset the text words are not found by the local word synthesis dictionary function; and
a transmission function for transmitting the invalid subset of text words over a network to a server device.

11. A personal communication device comprising the device for speech synthesis according to claim 10.
